(19) United States
(12) Patent Application Publication
(10) Pub. No.: US 2012/0277085 A1
(43) Pub. Date: Nov. 1, 2012

(54) METHODS FOR ENHANCING STRENGTH AND DURABILITY OF A GLASS ARTICLE

(76) Inventors: Dana Craig Bookbinder, Corning, NY (US); Richard Michael Fiacco, Corning, NY (US); Timothy Michael Gross, Waverly, NY (US)

(21) Appl. No.: 13/372,859

(22) Filed: Feb. 14, 2012

Related U.S. Application Data
(60) Provisional application No. 61/480,027, filed on Apr. 28, 2011.

(51) Int. Cl. C03C 23/00; C03C 3/00

(52) U.S. Cl. 501/11; 65/30.12

(57) ABSTRACT

A method for strengthening an alkali-containing glass article including: contacting a standardized glass article and aqueous vapor at about 80 to 500° C. for 0.5 to 400 hours at atmospheric pressure. A method for making a damage resistant, low-alkali, glass article including: contacting a standardized glass article and aqueous vapor at about 100 to 600° C. for about 0.5 to about 200 hours at atmospheric pressure. A strengthened and durable glass article prepared by the disclosed methods is disclosed. A display system that can incorporate the glass article, as defined herein, is also disclosed.

This application claims the benefit of priority under 35 U.S.C. §119 of U.S. Provisional Application Ser. No. 61/480,027, filed on Apr. 28, 2011, the content of which is relied upon and incorporated herein by reference in its entirety.

### BACKGROUND

The disclosure relates generally to glass articles having enhanced strength and durability properties, and to methods of making and using the glass articles.

### SUMMARY

The disclosure provides a glass article having enhanced strength and durability properties, and to methods of making and using the glass article. The methods of making can include, for example, contacting the glass with steam or hot water immersion at atmospheric pressure.

### BRIEF DESCRIPTION OF THE DRAWING(S)

In embodiments of the disclosure:

FIG. 1a shows FTIR results of Beta-OH content as measured through 1.3 mm thick Glass D (non-IOX) steam treated glass showing a 10 to 20% increase in bulk BOH.

FIG. 1b shows an FTIR Beta-OH profile of a cross-section of the steam treated 1.3 mm thick—Glass D (non-IOX) glass of FIG. 1a showing up to a 280% BOH increase within the first 10 microns of the surface and to a depth of about 60 to 70 microns compared to “as-received” glass baseline (0.526 abs/mm).

FIG. 2 is a Weibull plot of ring-on-ring data comparing 1.3 mm thick Glass D samples that were ion-exchanged (triangles) and samples that were ion-exchanged then water immersion treated at 95° C. for 240 hrs (squares).

FIG. 3 shows ring-on-ring strength testing data for 1.3 mm thick Glass C, that was ion exchanged and non-abraded, before (triangles) and after 96 hrs at 200° C. steam exposure (squares), that show improvements in strength after steam exposure.

FIG. 4 shows three schematics of exemplary mechanisms for steam or water immersion strengthening of alkali-containing glasses.

FIG. 5 shows a Weibull plot of ring-on-ring comparative strength improvement results for 0.69 mm thick Glass A articles that were SiC-abraded (triangles); SiC-abraded then heated in 400° C. for 4 days in 100% steam atmosphere at 1 atm. pressure (squares); and experiments where articles were SiC-abraded then heated in N₂ at 400° C. for 4 days (diamonds).

FIG. 6 shows a Weibull plot of ring-on-ring strength for 0.69 mm thick Glass A as-received (non-abraded) parts (triangles), as-received parts heated at 400° C. for 4 days in N₂ (diamonds), and as-received parts heated at 400° C. for 4 days in 100% steam atmosphere, 1 atm. pressure (squares).

FIG. 7 shows images of Vickers indents in Glass A samples without steam treatment (controls).

FIG. 8 shows images of Vickers indents in Glass A having steam treatment at 400° C., 1 atm. for 4 days demonstrating enhanced crack resistance.

FIG. 9. shows FTIR measured Beta-OH content through the average thickness of a steam treated Glass A sample showing an increase in BOH.

FIG. 10. shows the FTIR Beta-OH profile of a cross-section of steam treated Glass A of FIG. 9 and about a 900% increase in BOH within the first 15 microns of the surface and a depth of about 35 microns compared to “as-received” glass baseline (0.53 abs/mm).

### DETAILED DESCRIPTION

Various embodiments of the disclosure will be described in detail with reference to drawings, if any. Reference to various embodiments does not limit the scope of the invention, which is limited only by the scope of the claims. Additionally, any examples set forth in this specification are not limiting and merely set forth some of the many possible embodiments of the claimed invention.

### DEFINITIONS

“Standardized,” “standard,” or like terms refer to actual or simulated handling defects or surface flaws. In embodiments, standardized glass can be obtained by, for example, contacting the glass article with an abrasive, such as by sandblasting, or like abrading treatments, to simulate handling defects or surface flaws. In embodiments, standardized glass can be obtained by, for example, selecting glass articles that have been handled during typical post-manufacture unit operations that can be performed manually or autonomously, such as etching, polishing, washing, cleaning, picking, placing, conveying, stacking, wrapping, packing, testing, and like handling or processing operations.

“Low-alkali,” “alkali-free,” or like terms refer to, for example, an alkali content of less than about 0.5 wt %.

“Sharp contact” or like terms refer to, for example, a contact force that can permanently deform the surface of the glass article, such as simulated in a Vickers indentation analysis and like contact forces.

“IOX” refers to ion-exchanged glass.

“Non-IOX” refers to non-ion-exchanged glass.

“Include,” “includes,” or like terms means encompassing but not limited to, that is, inclusive and not exclusive.

“About” modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example: through typical measuring and handling procedures used for making compounds, compositions, composites, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. The claims appended hereto include equivalents of these “about” quantities.

“Consisting essentially of” in embodiments refers, for example: to a glass article having enhanced strength and durability properties resulting from contacting the glass article for a sufficient time with steam, hot water immersion, or a combination thereof, compared to an uncontacted glass article; to a glass surface having enhanced strength and durability properties resulting from the same contacting; to a method of making an enhanced strength and durability glass article; devices incorporating the article, or any apparatus of the disclosure, and can include the components or steps listed in the claim, plus other components or steps that do not materially affect the basic and novel properties of the compositions, articles, apparatus, or methods of making and use of the disclosure, such as particular reactants, particular additives or ingredients, a particular agent, a particular surface modifier or condition, or like structure, material, or process variable selected. Items that may materially affect the basic properties of the components or steps of the disclosure or that may impart undesirable characteristics to the present disclosure include, for example, a surface having low Vickers indentation crack resistance, that are beyond the values, including intermediate values and ranges, defined and specified herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, and like aspects, and ranges thereof, are for illustration only; they do not exclude other defined values or other values within defined ranges. The composition, device, apparatus, and methods of the disclosure can include any value or any combination of the values, specific values, more specific values, and preferred values described herein, including intermediate values and ranges.

Manufacturers of mobile phones, laptops, and other electronic devices are selecting glass, especially strengthened ion-exchanged glass, as the material of choice for the top cover piece on their flat panel display devices. Certain strengthened ion-exchanged glass can be further strengthened and its durability enhanced against damage according to the methods of making of the disclosure.

In embodiments, the disclosure provides a method of making a strengthened and durable glass article by contacting with steam or water immersion.

In embodiments, the disclosure provides a method for strengthening an alkali-containing glass article comprising, for example:

contacting a standardized glass article and aqueous vapor at about 80 to 500° C. for 0.5 to 400 hours at atmospheric pressure, such as 1 atmosphere.

The aqueous vapor can be, for example, at about 200 to about 300° C. for 0.5 to 100 hours. The contacting can be accomplished, for example, at a temperature at least below the anneal point of the bulk glass, for example, from 5 to 200° C. below the anneal point, and from 10 to 200° C. below the anneal point, from 100 to 200° C. below the anneal point. The water fraction in the aqueous vapor can be, for example, about 20 to 100% by volume, about 50 to 100% by volume, and like volume % values, including intermediate values and ranges.

In embodiments, the method can further comprise, for example, contacting the standardized glass article with an ion-exchange medium to strengthen the standardized glass article prior to contacting the standardized glass article and aqueous vapor.

In embodiments, the beta-OH content of the contacted glass surface can be, for example, at least 1.5 times greater than the beta-OH content of the center of the glass article, at least 2 times greater than the beta-OH content of the center of the glass article, at least 3 times greater than the beta-OH content of the center of the glass article, and like glass surface beta-OH contents. The beta-OH surface can be, for example, at least 1 micron and the glass article thickness can be, for example, at least 50 microns. The beta-OH surface can be, for example, at least 10 microns and the glass article thickness can be, for example, at least 100 microns. The beta-OH surface can be, for example, at least 50 microns and the glass article thickness can be, for example, at least 250 microns.

The beta-OH surface can have, for example, a decreasing gradient profile approaching the bulk glass.

In embodiments, the disclosure provides a method for strengthening an ion-exchanged alkali-containing glass article comprising, for example:

immersing a standardized glass article in liquid water at about 100 to 500° C. for 0.5 to 400 hours.

In embodiments, the disclosure provides a method for making a damage resistant, low-alkali, glass article comprising, for example:

contacting a standardized glass article and aqueous vapor at about 100 to 600° C. for about 0.5 to about 200 hours at atmospheric pressure.

The contacting can improve the indentation crack resistance of the contacted glass article by, for example, from about 5 to about 10% relative to an un-contacted glass article. The contacting can also heal or reduce the severity of existing handling flaws on the glass article by from about 10 to about 60% relative to an uncontacted glass article.

The contacting can also increase the resistance of the glass article to subsequent handling flaw formation from sharp contact.

In embodiments, the aqueous vapor can be, for example, at 300 to 500° C. for about 50 to about 120 hours at one atmosphere of pressure.

In embodiments, the standardized, low-alkali, glass can be obtained, for example, from abrasive treatment comprising contacting with 90 grit SiC, and like abrasive treatment methods.

In embodiments, the disclosure provides a glass article prepared by any of the disclosed methods, or method combinations thereof.

In embodiments, the disclosure provides methods for strengthening glass articles, such as glass sheets. In embodiments, the method can comprise, for example, steam or aqueous immersion treatment that can be applied to alkali-containing glasses including alkali-alumino silicates. Although not bound by theory, the method is believed to impregnate the contacted glass surface with H₂O molecules at atmospheric pressure.

In embodiments, the disclosure provides a method for strengthening, for example, alkali-containing glasses by steam or aqueous immersion treatment at temperatures less than the anneal point of the glass. Glass compositions that readily ion-exchange Na⁺ (glass) for K⁺ (KNO₃ salt), such as sodium alumino silicates (without prior ion-exchange), will also strengthen when exposed to steam. The disclosed steam or aqueous immersion treatment methods can be an alternative to traditional ion-exchange methods that enhance damage resistance. In addition, the disclosed post-ion-exchange (IOX) steam or aqueous immersion treatment can be used in place of other treatments such as HF etching used for surface strengthening or conditioning for surface properties, such as anti-glare and anti-reflection.

In embodiments, the disclosure provides a method comprising high temperature steam treatment to improve the strength of a display glass article that has had some strength limiting damage introduced by, for example, handling or mis-handling. The disclosure also provides a method to enhance the damage resistance of the glass.

In embodiments, steam treatment of the as-drawn or as-molded glass can be sufficient to increase damage resistance. Replacement of ion-exchange salt baths with a steam or water process can lead to considerable reduction in manufacturing costs. In ion-exchange processes the salt becomes contaminated with the smaller exchanged alkali ions from the glass substrate and has to be changed frequently. Deionized water is less expensive than KNO₃ salt and can be used fresh in every instance to provide the benefit of having a consistent compressive stress profile. In existing ion-exchange processes the compressive stress profile can change as the KNO₃ salt becomes contaminated with Na⁺ until the Na⁺ levels are unacceptable requiring production shut down and bath change-out.

In embodiments, when the glass is water-treated after being ion-exchanged, the surface layer gains compressive stress strength that improves mechanical test results, such as ring-on-ring strength on as-received glass. In embodiments, the disclosure provides a method for enhancing glass, such as display glass, strength and durability, that is, enhanced damage resistance. In embodiments, one of the disclosed methods comprises steam treatment that can be applied to, for example, non-alkali glasses including alkaline earth alumino silicates such as Glasses A and E in Table 1. The method comprises contacting glass with steam at atmospheric pressure as defined herein.

Particularly significant aspects of the disclosure of contacting a glass article with steam or hot water immersion include, for example: either treatment method improves the mechanical strength of glasses by reducing the severity of handling flaws. The steam treatment method also increases the resistance of the glass surface to the formation of new flaws. In embodiments, the method can provide one or more advantages or benefits, including for example: improved mechanical strength as measured by, for example, edge and ball drop methods; resistance to crack formation as measured by, for example, Vickers Hardness (indentation; see for example, www.instron.us and ASTM E384); and avoiding concentrated acid etch processing, such as HF, used for surface strengthening. These and other aspects of the disclosure are illustrated and demonstrated herein.

In embodiments, a significant and preferred condition for the disclosed method is that the contacting or treatment temperature remain relatively low, for example, below the anneal point of the glass, preferably at least 100 degrees below the anneal point of the as-initially formed glass, and more preferably at least 200 degrees below the anneal point of the glass, to achieve the disclosed enhanced mechanical attributes.

In embodiments, the article comprises, consists essentially of, or consists of one of a soda lime silicate glass, an alkaline earth aluminosilicate glass, an alkali aluminosilicate glass, an alkali borosilicate glass, and combinations thereof. Examples of such glasses are described herein. For additional definitions, descriptions, and methods of silica materials and related metal oxide materials, see for example, R. K. Iler, The Chemistry of Silica, Wiley-Interscience, 1979.

In embodiments, the glass article can be a transparent or semi-transparent glass sheet, such as those used as cover plates and windows for display and touch screen applications, for example, portable communication and entertainment devices such as telephones, music players, video players, or like devices; and as display screens for information-related terminal (IT) (e.g., portable or laptop computers) devices; and like applications. The glass article or substrate can have a thickness of up to about 3 millimeters (mm). In embodiments, the thickness can be from about 0.2 to about 3 mm.

In embodiments, the glass article can have at least one surface that is unpolished.

In embodiments, contacting the surface of the glass article or substrate can include additional optional preparative, pretreatment, or post-treatment procedures, for example, for removing oil, foreign matter, or other surface debris that may inhibit H₂O absorption, penetration, or imbibation, from at least one surface of the glass article using known methods, including, for example, washing with soaps or detergents, ultrasonic cleaning, treatment with surfactants, and like methods. Other optional preparative procedures can include, for example, etching at least one surface of the glass article using known methods.

In embodiments, a glass article is provided. The glass article can be, for example, a sheet that can be ion-exchanged or ion-exchangeable, and can have two smooth surfaces or at least one roughened surface. The roughened surface can have a distinctness-of-reflected image (DOI) of less than 90 when measured at an incidence angle of 20°. A pixelated display system that includes the glass article treated in accord with the present disclosure is also provided. The glass article can be, for example, a planar sheet or panel having two major surfaces joined on the periphery by at least one edge, although the glass article can be formed into other shapes such as, for example, a three-dimensional shape. At least one of the surfaces can be a roughened surface including, for example, topological or morphological features, such as, projections, protrusions, depressions, pits, closed or open cell structures, particles, and like structures or geometries, or combinations thereof.

In embodiments, the disclosure provides an aluminosilicate glass article. The aluminosilicate glass article can comprise at least 2 mol % Al₂O₃, can be ion-exchangeable, and has at least one roughened surface. The aluminosilicate glass article can have at least one roughened surface comprising a plurality of topographical features. The plurality of topographical features can have an average characteristic largest feature size (ALF) of from about 1 micrometer to about 50 micrometers.

In embodiments, the disclosure provides a display system. The display system can include at least one aluminosilicate glass panel and a pixelated image-display panel adjacent to the aluminosilicate glass panel. The image-display panel has a minimum native pixel pitch dimension. The average characteristic largest feature size of the glass panel can be less than the minimum native pixel pitch dimension of the display panel. The pixelated image display panel can be, for example, one of an LCD display, an OLED display, or like display devices. The display system can also include touch-sensitive elements or surfaces. The aluminosilicate glass can be ion-exchanged and has at least one roughened surface comprising a plurality of features having an average largest feature size, or ALF, and the image-displaying panel can have a minimum native pixel pitch. The minimum native pixel pitch can be, for example, greater than the ALF of the roughened surface of the aluminosilicate glass panel.

In embodiments, the alkali aluminosilicate glass can comprise, consist essentially of, or consist of, for example: 60-70 mol % SiO₂; 6-14 mol % Al₂O₃; 0-15 mol % B₂O₃; 0-15 mol % Li₂O; 0-20 mol % Na₂O; 0-10 mol % K₂O; 0-8 mol % MgO; 0-10 mol % CaO; 0-5 mol % ZrO₂; 0-1 mol % SnO₂; 0-1 mol % CeO₂; less than 50 ppm As₂O₃; and less than 50 ppm Sb₂O₃; wherein 12 mol % Li₂O+Na₂O+K₂O≦20 mol % and 0 mol % MgO+CaO≦10 mol %. In embodiments, the alkali aluminosilicate glass can comprise, consist essentially of, or consist of, for example: 60-72 mol % SiO₂; 9-16 mol % Al₂O₃; 5-12 mol % B₂O₃; 8-16 mol % Na₂O; and 0-4 mol % K₂O. In embodiments, the alkali aluminosilicate glass can comprise, consist essentially of, or consist of 61-75 mol % SiO₂; 7-15 mol % Al₂O₃; 0-12 mol % B₂O₃; 9-21 mol % Na₂O; 0-4 mol % K₂O; 0-7 mol % MgO; and 0-3 mol % CaO. In embodiments, the glass can be batched with 0 to 2 mol % of at least one fining agent, such as Na₂SO₄, NaCl, NaF, NaBr, K₂SO₄, KCl, KF, KBr, SnO₂, or combinations thereof. The aluminosilicate glass, in embodiments, can be substantially free of lithium. In embodiments, the aluminosilicate glass can be substantially free of at least one of arsenic, antimony, barium, or combinations thereof.

In embodiments, the selected glass can be, for example, down drawable, i.e., formable by methods such as slot draw or fusion draw processes that are known in the art. In these instances, the glass can have a liquidus viscosity of at least 130 kpoise. Examples of alkali aluminosilicate glasses are described in commonly owned and assigned U.S. patent application Ser. No. 11/888,213, to Ellison, et al., entitled “Down-Drawable, Chemically Strengthened Glass for Cover Plate,” filed Jul. 31, 2007, having priority to U.S. Provisional Appln 60/930,808, filed May 22, 2007; U.S. patent application Ser. No. 12/277,573, to Dejneka, et al., entitled “Glasses Having Improved Toughness and Scratch Resistance,” filed Nov. 25, 2008, which claims priority from U.S. Provisional Appln 61/004,677, filed Nov. 29, 2007; U.S. patent application Ser. No. 12/392,577, to Dejneka, et al., entitled “Fining Agents for Silicate Glasses,” filed Feb. 25, 2009, which claims priority from U.S. Provisional Appln No. 61/067,130, filed Feb. 26, 2008; U.S. patent application Ser. No. 12/393,241, to Dejneka, et al., entitled “Ion-Exchanged, Fast Cooled Glasses,” filed Feb. 26, 2009, which claims priority to U.S. Provisional Appln No. 61/067,732, filed Feb. 29, 2008; U.S. patent application Ser. No. 12/537,393, to Barefoot, et al., entitled “Strengthened Glass Articles and Methods of Making,” filed Aug. 7, 2009, having priority to U.S. Provisional Appln No. 61/087,324, entitled “Chemically Tempered Cover Glass,” filed Aug. 8, 2008; U.S. Provisional Patent Appln No. 61/235,767, to Barefoot, et al., entitled “Crack and Scratch Resistant Glass and Enclosures Made Therefrom,” filed Aug. 21, 2009; and U.S. Provisional Patent Appln No. 61/235,762, to Dejneka, et al., entitled “Zircon Compatible Glasses for Down Draw,” filed Aug. 21, 2009.

In embodiments, a particularly useful and popular glass composition for use in the disclosed process is Code 2318 glass, commercially available from Corning, Inc. (i.e., Corning® Gorilla® glass; see for example, U.S. Provisional Patent Application 61/235,762, supra.). The Code 2318 glass can have a composition specified within the following combined ranges, for example: 61 mol %≦SiO₂≦75 mol %; 7 mol %≦Al₂O₃≦15 mol %; 0 mol %≦B₂O₃≦12 mol %; 9 mol %≦Na₂O≦21 mol %; 0 mol %≦K₂O≦4 mol %; 0 mol %<MgO≦7 mol %; and 0 mol %≦CaO≦3 mol %. In embodiments, other suitable glass compositions for use in the disclosed methods can include, for example, low-alkali and alkali-containing glasses, such as those compositions listed in Table 1.

TABLE 1
Glass compositions used in steam treatment experiments.

| | Glass ID | | | | | |
|---|---|---|---|---|---|---|
| | A | B | C | D | E | F |
| Component | mol % | mol % | mol % | mol % | mol % | mol % |
| SiO₂ | 68 | 66 | 69 | 64 | 71 | 72 |
| Al₂O₃ | 11 | 10 | 9 | 14 | 12 | 1 |
| B₂O₃ | 10 | 1 | 0 | 7 | 1 | 0 |
| CaO | 9 | 1 | 1 | 0 | 5 | 9 |
| MgO | 2 | 6 | 6 | 0 | 5 | 6 |
| SrO | 1 | 0 | 0 | 0 | 1 | 0 |
| BaO | 0 | 0 | 0 | 0 | 4 | 0 |
| Na₂O | 0 | 14 | 14 | 14 | 0 | 12 |
| K₂O | 0 | 2 | 1 | 1 | 0 | 1 |
| Anneal Point | 723 | 600 | 609 | 600 | 787 | 552 |
| (° C.) | | | | | | |
| 10^{13.2} Poise | | | | | | |

### EXAMPLES

The following examples serve to more fully describe the manner of using the above-described disclosure, and to further set forth the best modes contemplated for carrying out various aspects of the disclosure. It is understood that these examples do not limit the scope of this disclosure, but rather are presented for illustrative purposes. The working examples further describe the methods of how to prepare the glass articles of the disclosure.

FTIR beta-OH Content Characterization.

The beta-OH content of the steam treated samples was measured by FTIR. IR analysis of hydrated glass was performed as follows. Measurements were conducted using a Nicolet 8700 bench (Thermo Fisher Scientific, Waltham, Mass.) with a DTGS detector and XT-KBr beam splitter. 128 scans were taken at 16 cm⁻¹ resolution with a gain of 1. Each glass spectrum is relative to an open beam through the same 5 mm aperture in the nitrogen purged sample compartment.

The β-OH content (also known as BOH or beta-OH) was calculated from the spectral transmittance at two frequencies (or wavelengths): at a reference frequency, 3900 cm⁻¹ (2.56 microns); and at the frequency of minimum transmittance of the hydroxyl band near 3550 cm⁻¹ (2.8 microns), with the latter frequency being composition dependent and can be from about 2.6 to 2.9 microns.

The β-OH content can be calculated by:

β-OH content=(1/x)·log₁₀(T_{Ref}/T_{OH})

where T_{Ref}=Transmittance at reference frequency, 3900 cm⁻¹, T_{OH}=Transmittance at OH minimum about 3550 cm⁻¹), and x=thickness of sample (mm).

Glass Etch Conditions.

Glass samples were chemically etched at room temperature (about 23° C.) using an aqueous solution of 1.5 M HF/0.9 M H₂SO₄ for the stated period of time then triple rinsed in DI water at room temperature. An FTIR measurement followed each acid treatment. After each acid etching step a thickness measurement was taken over about ten equally spaced areas of the glass using a digital micrometer, recorded, and averaged to determine the average etching rate for each sequence. The acid bath was replaced prior to each etching sequence.

### Example 1

### Steam or Water Immersion Treatment of Non-Ion-Exchanged Alkali Containing Glasses

In embodiment, alkali alumino silicates (glasses B to D in Table 1, without prior ion-exchange) all had Vickers indentation crack resistance exceeding 2 kgf (kilograms force) following treatment in 100% steam atmosphere at atmospheric pressure. As an alternative to steam treatment, the alkali-containing glass samples were immersed in liquid water at elevated temperatures and achieved a high surface compression layer.

In embodiment, the disclosed strengthening method includes steam treatment or water immersion for achieving enhanced damage resistance of glasses containing ion-exchangeable alkalis. Traditionally, ion-exchange glass strengthening is performed by treatment of glasses containing smaller alkalis, e.g., Na⁺, in a salt containing larger alkalis, e.g., K⁺. Non-ion-exchanged samples of alkali alumino silicates (glasses B to D in Table 1), showed enhanced Vickers crack resistance following steam treatment at 250° C. for 3 days. Non-ion-exchanged glass B had a Vickers crack initiation load of 300 to 500 gf (grams force). Following steam treatment the Vickers crack initiation load of glass B was increased to greater than 2000 gf. Non-ion-exchanged glass C had Vickers crack initiation load of 200 to 300 gf. Following steam treatment the Vickers crack initiation load was increased to 1000 to 2000 gf. Non-ion-exchanged Glass D had Vickers crack initiation load of 1000 to 2000 gf. Following steam treatment the Vickers crack initiation load was increased to greater than 2000 gf. The results of steam treating non-ion-exchanged glasses showed strength increases of about 2 to about 10 fold compared to the same glass sample without the steam or water immersion treatment.

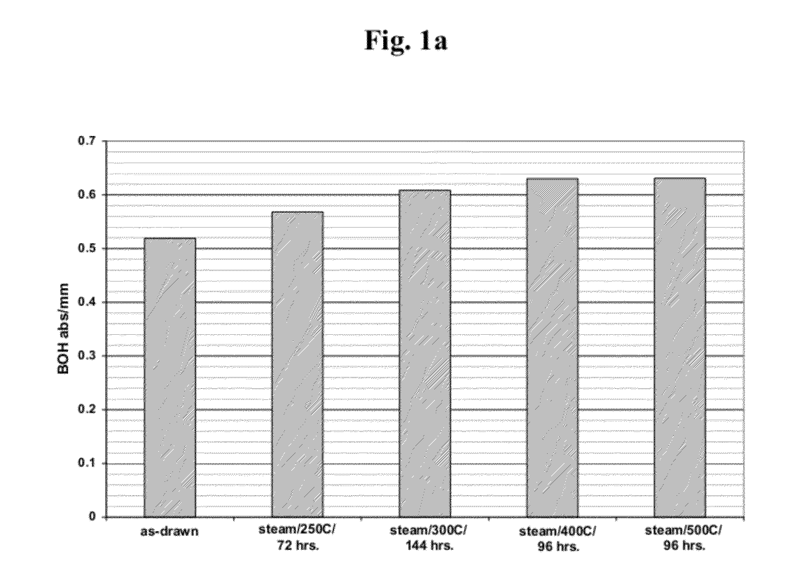

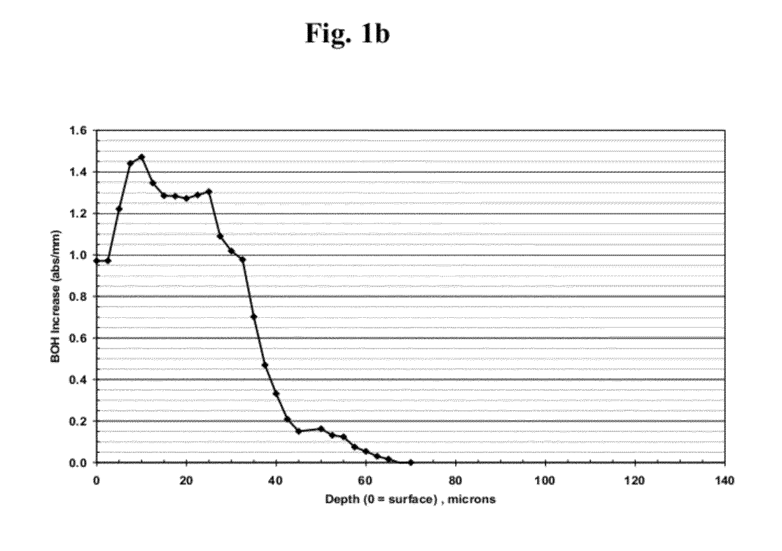

The etching and measurement sequence was continued until loss of glass resulted in no change to BOH indicating the complete loss of the enriched hydroxyl layer. The data is plotted in FIG. 1a as bulk (average) BOH for the total thickness, and in FIG. 1b as BOH increase over the unexposed glass sample, as a function of depth from the surface. Steam exposure of glass samples can be used to increase the BOH of the surface of a glass article (i.e., the outer 5 to 30 percent of a sample, e.g., 15 to 100 microns of a sample having a total thickness of 300 microns or more).

Samples of 1.3 mm thick Glass D (an alkali-containing glass) were exposed to a 100% steam containing atmosphere at 1 atm. pressure, for temperatures selected from 250 to 500° C., and for times selected from 72 to 144 hours. The results show an increase in BOH of 10 to 21% when averaged across the entire thickness of the samples (see FIG. 1a). Upon further characterization using the above described HF etching technique, the increased BOH was found to be in the surface region of the glass samples, i.e., on the outer 10 to 70 microns of the glass article surface. For example, a sample of Glass D exposed to 100% steam containing atmosphere at 1 atm. pressure and at 500° C. for 96 hours showed an increase in BOH of as much as 280% within the first 10 microns of the surface (1.48/0.526) and a depth of about 60 to 70 microns (FIG. 1b). As shown in Table 2, the increase of BOH can be controlled by exposing samples to different temperatures, times, and partial pressures of steam in the atmosphere. Higher temperatures, longer times, higher steam partial pressures, or a combination thereof yielded higher BOH content. Different glass compositions can also have an affect on BOH increase with these steam exposure parameters. For example, glasses B to D, and F show a 17 to 39 percent increase in BOH (averaged through the entire glass thickness), as described above. This increase is generally at the surface of the glass sample when steam exposed at 300° C. for 144 hours. In general, a greater increase in BOH occurs at higher temperatures, even when exposure times are shorter. Glasses A and F are non-alkali containing glasses and show, for example, a 4 to 39% BOH increase at 300° C. for 144 hours, and a greater increase in BOH at higher temperatures, even when exposure times are shorter.

Table 2 shows that an increase of BOH can be controlled by exposing samples to different temperatures, times, and partial pressures of steam in the atmosphere, where “NA” refers to not tested, and “steam” refers to 1 atmosphere pressure of 100% steam.

TABLE 2

| | | Glass ID | | | | | |
|---|---|---|---|---|---|---|---|
| | | A | B | C | D | E | F |
| | Glass | 0.69 | 1.29 | 1.07 | 1.30 | 0.69 | 0.97 |
| | thickness (mm) | | | | | | |
| Glass | BOH, | 0.530 | 0.319 | 0.258 | 0.526 | 0.218 | 0.082 |
| Treatment | averaged | | | | | | |
| | through | | | | | | |
| | thickness | | | | | | |
| | (abs/mm) | | | | | | |
| steam/250° C./ | % increase | NA | NA | NA | 9 | NA | NA |
| 72 hrs | in BOH | | | | | | |
| steam/300° C./ | % increase | 4 | 17 | 25 | 17 | 5 | 39 |
| 144 hrs | in BOH | | | | | | |
| steam/400° C./ | % increase | 7 | 21 | 32 | 21 | 6 | 46 |
| 96 hrs | in BOH | | | | | | |
| steam/500° C./ | % increase | 11 | 15 | 36 | 22 | 164 | 123 |
| 96 hrs | in BOH | | | | | | |

### Example 2

### Steam or Water Immersion Treatment of Glasses Post-Ion-Exchange

Steam or water immersion treatment of glass can also be used post-ion-exchange to enhance the compression layer near the surface. Immersion in water at 95° C. for 240 hrs showed a significant increase in the ring-on-ring load-at-failure of ion-exchanged glass D samples when compared to those samples that were ion-exchanged, but not water immersion treated. There was an improvement in strength at all failure loads. The largest improvement in ring-on-ring load-at-failure occurred at the high end of the strength distribution; this is where the smallest flaws (i.e., about 1 micron or less) were present. The post-ion-exchange steam or water immersion treatment is sufficiently effective to replace or supplement other surface strengthening treatments, such as HF etching, used for surface strengthening.

Following standard ion-exchange treatments for alkali alumino silicates (glasses B to D in Table 1), in which Na⁺ is exchanged for K⁺, the glass can be treated in water or steam at low to moderate (up to several hundred degrees C.) temperatures to achieve additional surface strengthening. Ion-exchanged samples of glass D were water-immersion treated by holding the samples in distilled water at 95° C. for 240 hrs and then tested by ring-on-ring. The average ring-on-ring load-at-failure for the 1.3 mm thick ion-exchanged parts without water immersion treatment was 408 kgf. The average ring-on-ring load at failure for the 1.3 mm thick ion-exchanged parts then water treated was 503 kgf (i.e., a 23% increase). The strength distribution for ring-on-ring testing shows that the advantage gained from water treatment was at the high end of the strength distribution for specimens that failed from small flaws.

Non-ion-exchanged test glass samples B to D were tested under various steam treatment conditions. Following steam treatment the Vickers indentation thresholds were measured for the treated glasses. When the glasses were treated in 100% steam atmosphere (at 1 atm. pressure) and at a lower temperature of, for example, 250° C. for 3 days, the Vickers indentation threshold was enhanced in each glass as shown in Table 3.

TABLE 3
Vickers indentation of non-ion-exchanged samples (control) and non-
ion-exchanged samples following steam treatment.

| | Untreated Vickers | Steam Treated Vickers | % |
|---|---|---|---|
| | indentation threshold | indentation threshold for | increase in |
| | for non-ion- | non-ion-exchanged (treated | Vickers |
| Glass | exchanged, grams | in 1 atm steam, 250° C., 3 | indentation |
| ID | force (gf) | days, grams force) (gf) | threshold |
| B | 300-500 | >2000 | 300-570 |
| C | 200-300 | 1000-2000 | 230-900 |
| D | 1000-2000 | >2000 | 100 |

As mentioned above, FTIR was used to characterize the beta-OH profile of 1.3 mm thick glass D (non-IOX) glass samples that were steam treated under varying conditions. The results showed a 10 to 20% increase in bulk OH (FIG. 1a). FIG. 1b shows FTIR results for a cross-section of steam treated (250° C., 3 days, 1 atm.) sample from FIG. 1a. This sample showed up to about 3.5 fold increase in OH on the first 50 to 100 microns of the glass surface, and that all of the increase in OH in the sample is near the glass surface. Other glass samples which were steam treated showed an eight fold or greater increase in beta-OH on the surface compared to the bulk glass. Although not bound by theory, it is believed that the higher relative beta-OH concentration and thicker beta-OH layer (about 100 microns) may further improve the toughness properties of the glass articles.

The Vickers crack initiation load of Glass B went from 300 to 500 gf in the untreated glass to greater than 2000 gf after steam treatment. The Vickers crack initiation load of Glass C went from 200 to 300 gf in the untreated glass to 1000 to 2000 gf after steam treatment. The Vickers crack initiation load of Glass D went from 1000 to 2000 gf in the untreated glass to greater than 2000 gf after steam treatment.

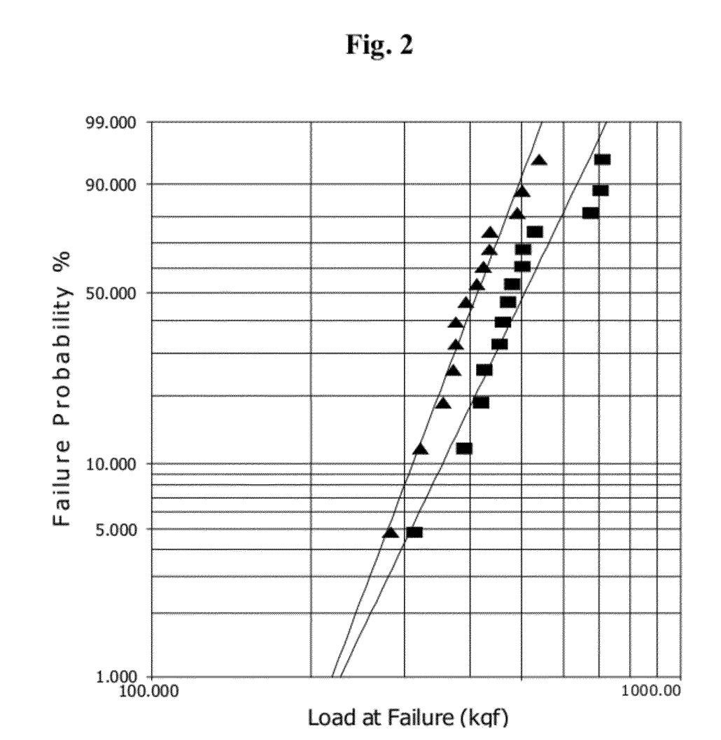

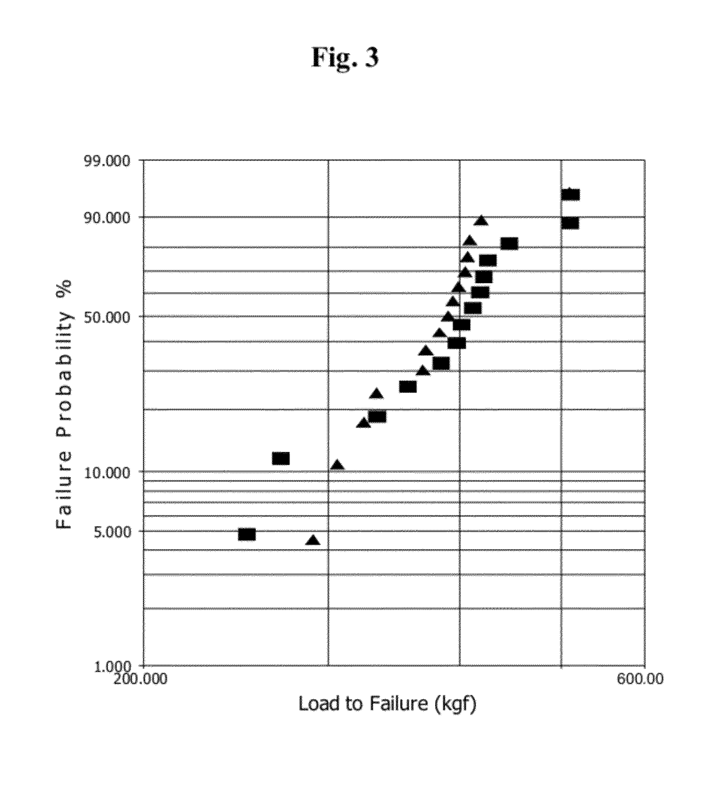

Samples of ion-exchanged 1.3 mm thick Glass D (compressive stress=772 MPa, depth of layer of 49 microns) were treated post-ion-exchange (i.e., after being ion-exchanged) by water immersion in distilled water at 95° C. for 240 hr. The results of ring-on-ring mechanical testing as shown in FIG. 2 and FIG. 3 indicated that the high end of the strength distribution for the water immersion or steam treated glasses, respectively, showed much higher failure load values. This result is consistent with a mechanism for reducing the strength limitations in glass as a result of small flaws. Data from the high end of the strength distribution comes from failures at small flaw depths, so the strength of these samples would yield the greatest improvement by the shallow high compression layer.

FIG. 2 show a Weibull plot of ring-on-ring data comparing 1.3 mm thick glass D samples that were ion-exchanged (triangles) and samples that were ion-exchanged then water immersion treated at 95° C. for 240 hrs (squares). FIG. 3 shows data for glass C, ring on ring strength testing, ion exchanged, non-abraded, before (triangles) and after 96 hrs at 200° C. in steam (squares), showing improvements in strength after steam exposure. It is evident from the FIG. 3 plot that the advantage of the water immersion treatment (is at the high end of the strength distribution where flaw sizes are the smallest and most impacted by the shallow high compressive layer stress.

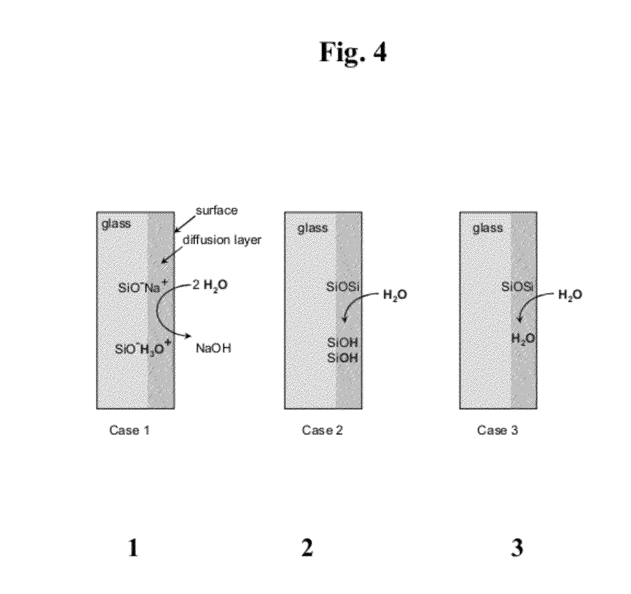

Although not bound by theory, FIG. 4 illustrates three schematics of possible mechanisms for steam strengthening of alkali-containing glasses of the disclosed methods. For example, the steam water molecules may react with the glass so that the larger H₃O⁺ ions exchange with the smaller Na⁺ ions to yield compressive stress at the surface (1). Alternatively or additionally, the glass may react with water molecules (2) (e.g., Si—O—Si+H₂O→SiOH+HOSi), the glass may become stuffed with water molecules (3), or combinations of one or more of the above mechanisms.

The disclosed process that provides beta-OH profiles having improved strength and durability properties for treated glass samples are expected to be applicable to other glasses including, for example, Corning code 7740 (e.g., Pyrex®), and (non-alkali) alkaline earth alumino silicates such as Glasses A and E in Table 1.

In embodiments, the disclosure also relates to surface strengthening of silicate display glasses by steam treatment. In embodiments, the disclosure provides a method to improve the strength of the glass comprising steam treating a glass article having an abraded surface. The method can be applied to, for example, (non-alkali) alkaline earth alumino silicates such as glasses A and E in Table 1 to blunt, heal, or both, surface flaws caused by handling damage. In embodiments, water and steam treatments have been applied to glasses to improve their strength. Abraded silica glass that was treated in 100% steam atmosphere (1 atm. pressure) at 250° C. for 4 days showed a greater than 200% increase in the strength of the specimens.

Steam treatment of (non-alkali) alkaline earth alumino silicates, such as Glasses A and E in Table 1, also shows an improvement in the indentation crack resistance.

### Example 3

### Ring-On-Ring Strength Testing

Strength testing using ring-on-ring methods was used to determine the strengths of Glass A samples following abrasion and subsequent high temperature steam treatment. Abrasion was performed by blasting the surface of the glass with 1 cm³ of 90 grit SiC at 5 psi for 5 sec. A mask was used to contain the abrasion to a circle of 10 mm diameter in the center of the 50 mm×50 min square glass specimens. Ring-on-ring strength testing was performed at room temperature at 50% RH with a support ring of 25.4 mm and a loading ring of 12.7 mm. The loading rate was fixed at 1.2 mm/min. Table 4 list the data for 0.69 mm thick Glass A samples that were: abraded with 90 grit SiC then treated in 100% steam atmosphere at 400° C., 1 atm. pressure for 96 hours; abraded with 90 grit SiC then treated in N₂ at 400° C. for 96 hours; and untreated after abrasion with 90 grit SiC (control, i.e., not treated with either steam or nitrogen).

Table 4 shows Glass A (0.69 mm thick) as-formed, non-abraded, and abraded with 90 grit SiC, then treated under different conditions, followed by ring-on-ring strength testing. Table 3 above also shows the data for non-abraded samples that were treated in 100% steam atmosphere at 400° C., 1 atm., for 96 hours, in N₂ at 400° C. for 96 hours; and untreated samples (i.e., tested as-is).

TABLE 4

| | Glass ID | |
|---|---|---|
| | A | |
| | Glass thickness, mm | |
| | 0.69 | |
| | Average | |
| | ring-on-ring | 1.29 |
| | failure load | Average |
| | (std. dev.), | strength (std. |
| Treatment | kgf | dev.), MPa |
| as-formed, then abraded with 90 | 6.6 (0.4) | 58.3 (3.9) |
| grit SiC | | |
| as-formed, then abraded with 90 | 8.0 (0.9) | 70.6 (8.0) |
| grit SiC, then heat treated in N₂ at | | |
| 400° C. for 96 hours | | |
| as-formed, then abraded with 90 | 9.4 (1.1) | 82.9 (9.4) |
| grit SiC, then heat treated in 1 atm | | |
| 100% steam at 400° C. for 96 hours | | |
| as-formed (not abraded) | 20.5 (10.5) | 179.8 (92.4) |
| as-formed (not abraded), then heat | 25.4 (11.5) | 223.7 (101.0) |
| treated in N₂ at 400° C. for 96 hours | | |
| as-formed (not abraded), then heat | 37.6 (14.7) | 330.8 (129.6) |
| treated in 1 atm 100% steam at | | |
| 400° C. for 96 hours | | |

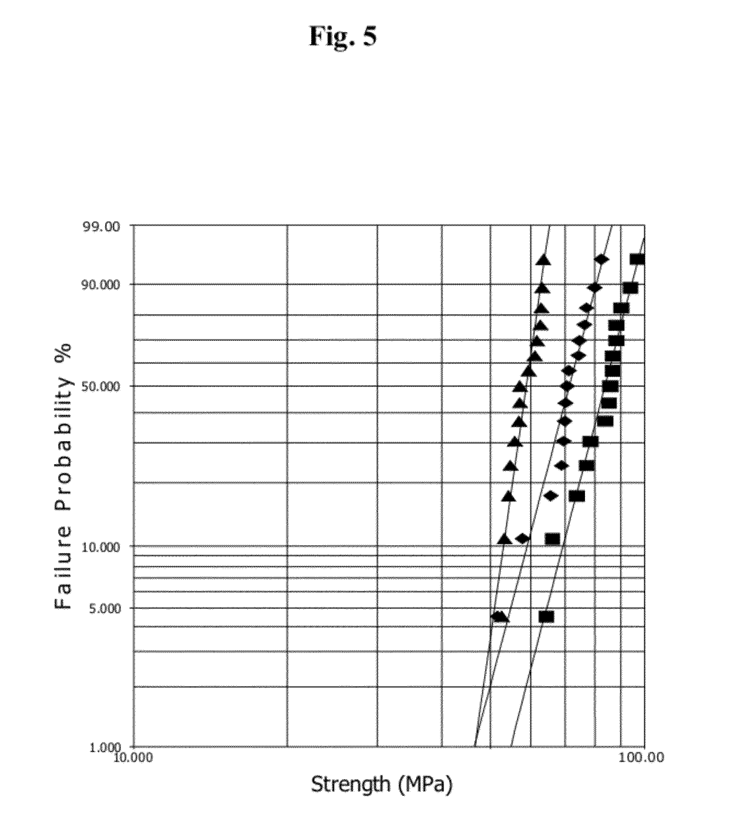

Parts tested as-drawn, and then abraded, had an average abraded strength of 58 MPa. Parts that were heat-treated in N₂ had an average abraded strength of 71 MPa (22% median strength increase). Parts that were steam treated had an average abraded strength of 83 MPa for about a 43% median strength increase for the steam treated samples compared to the samples that were heat-treated in N₂. The Weibull plot comparing these three data sets is given in FIG. 5. The ring-on-ring strength improvements were for 0.69 mm thick Glass A articles that were SiC-abraded (control) (triangles), Glass A articles that were SiC-abraded then heated at 400° C. for 4 days in N₂ (control) (diamonds), and Glass A articles that were SiC-abraded then heated at 400° C. for 4 days in 100% steam atmosphere at 1 atm. pressure (squares).

These results indicate that the steam treatment was most effective in increasing the strength of Glass A samples. Heat treatment in N₂ increased the strength when compared to the non-treated samples and was possibly due to the relief of residual stress at the tips of the flaws. Although not bound by the theory, the steam treatment in the disclosed experiments was more effective possibly because it promoted residual stress relaxation or it blunted or healed the flaws. The Weibull plot shown in FIG. 5 also demonstrated that the enhancement in strength of the steam-treated parts extended down to the lowest strength flaws, whereas the parts heat-treated in N₂ and tested as-is had overlap at the low strengths. This means that the steam treatment was effective in increasing strength even for the most severe flaws.

Table 4 shows the data for non-abraded samples that were treated in 100% steam atmosphere at 400° C., 1 atm. for 96 hours, in N₂ at 400° C. for 96 hours; and untreated (control, i.e., tested as-is).

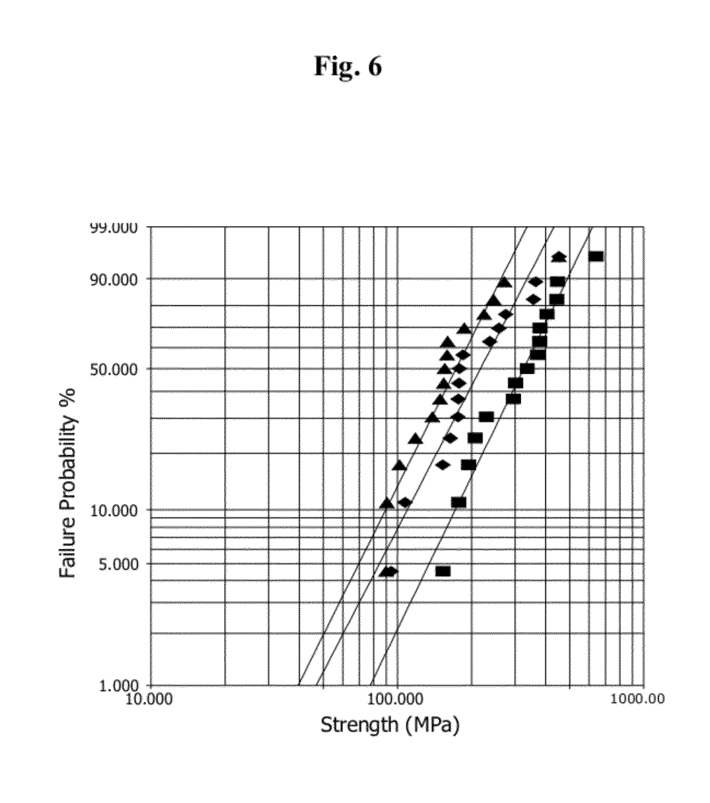

The non-abraded samples were tested under these various conditions to understand the effect of treatment on samples that undergo typical handling damage. Parts tested as-drawn had an average strength of 180 MPa. Parts that were heat-treated in N₂ had an average strength of 224 MPa (24% median strength increase). Parts that were steam treated had an average strength of 331 MPa (about an 84% median strength increase). The Weibull plot comparing these three data sets is shown in FIG. 6. FIG. 6 shows a Weibull plot of ring-on-ring strength improvements for 0.69 mm thick Glass A as-received (non-abraded) articles (triangles), as-received articles heated at 400° C. for 4 days in N₂ (diamonds), and as-received articles heated at 400° C. for 4 days in 100% steam atmosphere, 1 atm. pressure (squares). Even at the low end of the strength distribution, there was a significant improvement for the steam treated glass articles. Heat-treatment in N₂ resulted in a considerable strength increase over as-received parts, but was not advantageous at the low end of the strength distribution where the data overlaps that of as-received parts.

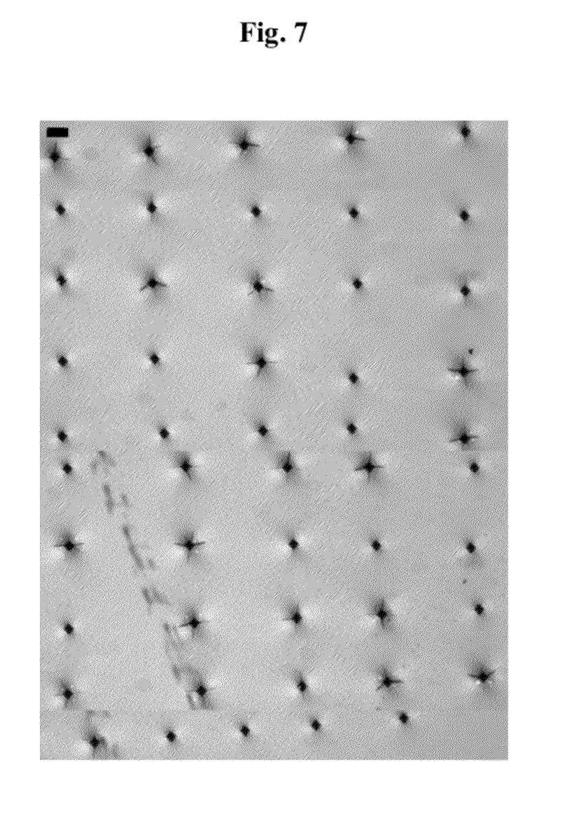

FIG. 7 shows images of Vickers indents in 0.69 mm thick Glass A samples which did not have steam treatment (“untreated” control, as-drawn, as-received). 28 of 50 Vickers indents made at 2000 grams force had radial/median cracks accompanying the impression. In most cracked indents, the radial cracks extended from all four corners of the indent.

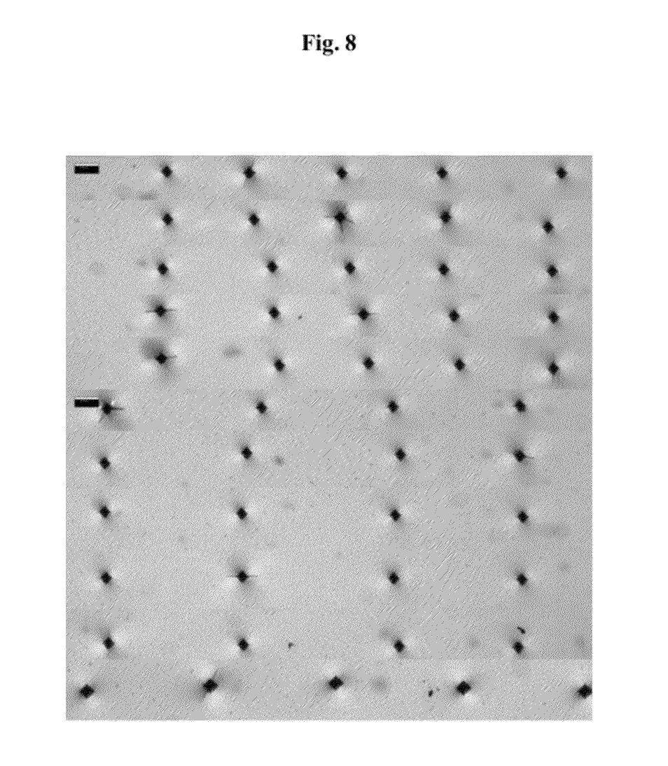

FIG. 8 is a micrograph digitally combined (side-by-side) to show 50 Vickers indents made in an as-received specimen of 0.69 mm thick Glass A having steam treatment at 400° C., 1 atm. for 4 days demonstrating enhanced crack resistance. 11 out of 50 Vickers indents made at 2000 grams force had radial/median cracks accompanying the impression. Some of the indents showed 6 to 8 cracks.

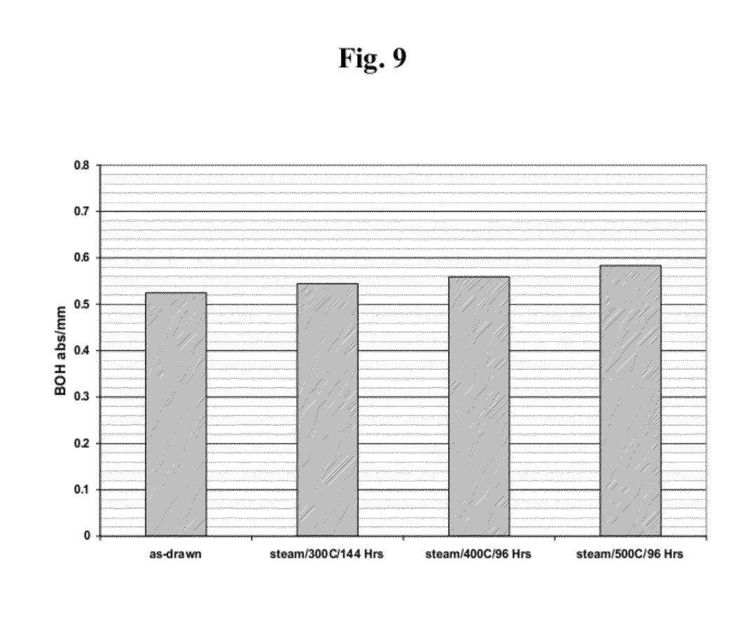

FIG. 9 shows FTIR measured Beta-OH content of Glass A samples through an average thickness of the sample of 0.69 mm that was steam treated. The results show a 4 to 11% increase in BOH.

When comparing FIGS. 8 and 9, it can be seen that the number of cracks per cracked indent is significantly improved (reduced) for the steam-treated samples. This indicates that the post-indentation residual stress is greater for indents in the as-received glass when compared to the residual stress for indents in the steam-treated glass. The results demonstrate that the disclosed steam treatment of these glasses toughened the glass surface.

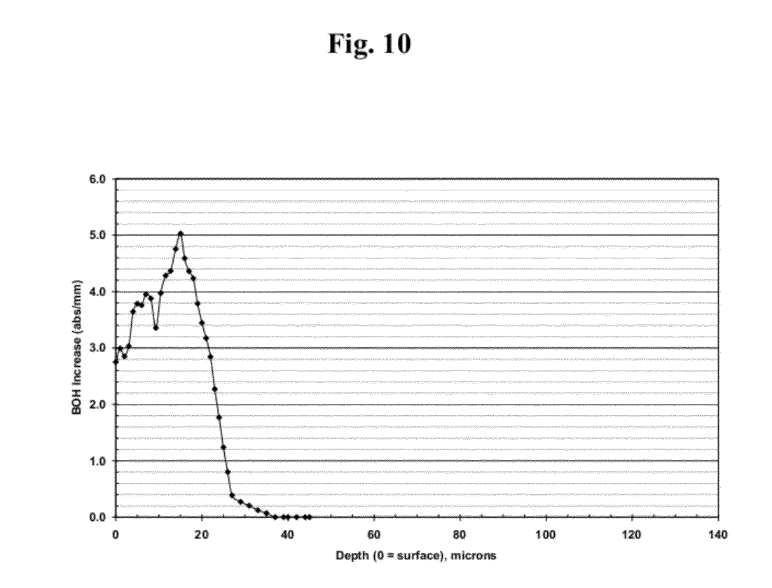

FTIR Beta-OH as measured through 0.69 mm thick steam treated Glass A showed a 4 to 11% increase in OH (FIG. 9). The cross-sectional OH profile for the Glasses A and E glass samples is believed to increase the OH content in the first 10 to 100 microns of the surface. FIG. 10 shows the FTIR Beta-OH profile of a cross-section of steam treated 0.69 mm thick glass A of FIG. 9 etched at about 23° C. by submersing the glass 2 minutes at a time in an aqueous solution containing 1.5 M HF/0.9 M H₂SO₄, then re-measuring the sample by FTIR. The data is plotted as Beta-OH increase over “as-received” glass which had 0.53 abs/mm throughout the entire glass thickness. The results demonstrate up to a 900% increase in BOH within the first 15 microns of the surface and a depth of about 35 microns (500° C., 75 days, 100% steam at 1 atm). Another sample of Glass A (not shown in this figure) was treated at 500° C., 4 days in a 100% dry nitrogen atmosphere at 1 atm pressure. This sample was then etched in HF/H₂SO₄ as described above, then characterized by FTIR. The nitrogen exposed sample showed a reduction of about 1% in beta-OH in the first 5 microns over the “as-received” glass.

Other glass samples which were steam treated showed an eight fold or greater increase in beta-OH on the surface vs. the bulk glass. Although not bound by theory, it is believed that a greater relative beta-OH content and deeper beta-OH layer (e.g., about 100 microns) can further improve the toughness of the treated glass articles.

The disclosure has been described with reference to various specific embodiments and techniques. However, it should be understood that many variations and modifications are possible while remaining within the scope of the disclosure.

What is claimed is:

1. A method for strengthening an alkali-containing glass article comprising:
contacting a standardized glass article and aqueous vapor at about 80 to 500° C. for 0.5 to 400 hours at atmospheric pressure.

2. The method of claim 1 wherein the water fraction in the aqueous vapor is at about 20 to 100% by volume.

3. The method of claim 1 wherein the water fraction in the aqueous vapor is at about 50 to 100% by volume.

4. The method of claim 1 wherein the aqueous vapor is at about 200 to about 300° C. for 0.5 to 100 hours.

5. The method of claim 1 wherein the contacting is accomplished at a temperature below the anneal point of the bulk glass.

6. The method of claim 1 further comprising contacting the standardized glass article with an ion-exchange medium to strengthen the standardized glass article prior to contacting the standardized glass article and aqueous vapor.

7. The method of claim 1 wherein a beta-OH content of the contacted glass surface is at least 1.5 times greater than the beta-OH content of the center of the glass article.

8. The method of claim 1 wherein a beta-OH content of the contacted glass surface is at least 3 times greater than the beta-OH content of the center of the glass article.

9. The method of claim 1 wherein the beta-OH surface is at least 1 micron and the glass article thickness is at least 50 microns.

10. The method of claim 1 wherein the beta-OH surface is at least 10 microns and the glass article thickness is at least 100 microns.

11. The method of claim 1 wherein the beta-OH surface is at least 50 microns and the glass article thickness is at least 250 microns.

12. The method of claim 1 wherein the beta-OH surface has a decreasing gradient profile approaching the bulk glass.

13. A method for strengthening an ion-exchanged alkali-containing glass article comprising:
immersing a standardized glass article in liquid water at about 80 to 100° C. for 0.5 to 400 hours.

14. A glass article prepared by the method of claim 1.

15. A method for making a damage resistant, low-alkali, glass article comprising:
contacting a standardized glass article and aqueous vapor at about 100 to 600° C. for about 0.5 to about 200 hours at atmospheric pressure.

16. The method of claim 15 wherein contacting increases the indentation crack resistance of the contacted glass article by 5 to 10% relative to an un-contacted glass article, and reduces the severity of existing handling flaws on the glass article by from about 10 to about 60% relative to an uncontacted glass article.

17. The method of claim 15 wherein contacting increases the resistance of the glass article to subsequent handling flaw formation from sharp contact.

18. The method of claim 15 wherein the aqueous vapor is at 300 to 500° C. for about 50 to about 120 hours.

19. The method of claim 15 wherein the standardized, low-alkali, glass is obtained from abrasive treatment comprising contacting with 90 grit SiC.

20. A glass article prepared by the method of claim 15.
